(19) United States
(12) Patent Application Publication
(10) Pub. No.: US 2023/0392968 A1
(43) Pub. Date: Dec. 7, 2023

(54) PIT LEVEL SENSING MONITOR

(71) Applicant: BECS Technology, Inc., St. Louis, MO (US)

(72) Inventors: Steve HENDRICKS, St. Louis, MO (US); Christopher A. MARK, St. Louis, MO (US); Todd STEINBRUECK, St. Louis, MO (US)

(21) Appl. No.: 18/200,753

(22) Filed: May 23, 2023

Related U.S. Application Data
(60) Provisional application No. 63/349,651, filed on Jun. 7, 2022.

(51) Int. Cl. G01F 23/14

(52) U.S. Cl. CPC G01F 23/14

(57) ABSTRACT

A level sensing monitor adapted to be partially disposed in a reservoir containing waste material to determine the level of material contained within the reservoir includes an inlet positioned on a lower end of the monitor adapted to be positioned near a bottom of the reservoir, a pressure transducer positioned on an upper end of the monitor distal from the inlet, a substantially airtight hollow pipe coupled between the inlet and the transducer such that the transducer will reside above an upper level of the reservoir, and a wiring enclosure housing a wiring cable for communicating readings from the transducer, with the wiring enclosure vented to ambient air to provide a source of ambient pressure to the pressure transducer.

### CROSS-REFERENCE TO RELATED APPLICATIONS

This application claims priority to U.S. Provisional Patent Application No. 63/349,651, filed Jun. 7, 2022, the contents of which are incorporated herein by reference.

### FIELD OF THE DISCLOSURE

The present disclosure generally relates to hog waste pits and, more particularly, to an improved monitor for measuring the amount of material in the waste pits.

### BACKGROUND

Hog confinement buildings typically house hundreds of animals that produce a substantial volume of urine and manure waste. The buildings normally have a slatted floor through which these waste materials fall into a pit or reservoir, which must periodically be removed before the pit fills to capacity. The urine and manure waste material in the reservoir produces noxious gasses, including hydrogen sulfide, ammonia, and methane. It is beneficial for the farmers to know the level of material in the reservoir so that the reservoir can be emptied prior to becoming full, and because a buildup of noxious gasses creates health and safety concerns for both the hogs and the farmers.

Certain prior art liquid level sensing systems include a pressure transducer placed at the bottom of the reservoir and the measured pressure is linearly related to the level of the material in the reservoir. The use of this type of conventional liquid level sensing system in manure pits is not optimal as the pressure transducer itself is immersed in the liquid being measured. The liquid and material contained in a hog pit reservoir can be destructive to the transducer, and the pressure washing cleaning commonly used when the pit is emptied can place too much stress on the transducer.

Therefore, it is desirable to have a level sensing system for a hog pit reservoir in which the pressure transducer is not physically immersed in the pit.

### SUMMARY OF THE DISCLOSURE

Among the various aspects of the present invention is the provision of a level sensing monitor adapted to be partially disposed in a reservoir containing waste material along an axis of measurement to determine the level of material contained within the reservoir. The monitor preferably includes an inlet positioned on a lower end of the monitor adapted to be positioned near a bottom of the reservoir, with the inlet having a diameter. The sensing monitor also includes a pressure transducer positioned on an upper end of the monitor distal from the inlet and a substantially airtight hollow pipe coupled between the inlet and the transducer such that the transducer will reside above an upper level of the reservoir. Preferably, the pipe has a diameter that is smaller than the diameter of the inlet. The sensing monitor further includes a wiring enclosure housing a wiring cable for communicating readings from the transducer, wherein the wiring enclosure is vented to ambient air to provide a source of ambient pressure to the pressure transducer.

### BRIEF DESCRIPTION OF THE DRAWINGS

These and other features, aspects and advantages of the disclosure will become more fully apparent from the following detailed description, appended claims, and accompanying drawings, wherein the drawings illustrate features in accordance with exemplary aspects of the disclosure, and wherein:

FIG. 1 is a side view of one embodiment of a level sensing monitor;

FIG. 2 is a cutaway view of the sensing monitor of FIG. 1 along line 2-2;

FIG. 3 is a side view of another embodiment of a level sensing monitor partially disposed in a reservoir;

FIG. 4 is a cutaway view of the sensing monitor of FIG. 3 along line 4-4;

FIG. 5 is a side view the level sensing monitor of FIG. 3; and

FIG. 6 is a view of the inlet of the sensing monitor showing the detail of 6 from FIG. 5.

### DETAILED DESCRIPTION

The accompanying figures and this description depict and describe embodiments of a level sensing monitor in accordance with the present disclosure, and features and components thereof. It should also be noted that any references herein to front and back, right and left, top and bottom, upper and lower, and first, second, third, and fourth are intended for convenience of description, not to limit the present invention or its components to any one positional or spatial orientation.

Before any aspects of the disclosure are explained in detail, it will be understood that the disclosure is not limited in its application to the details of construction and the arrangement of components set forth in the following description or illustrated in the following drawings. The disclosure is capable of other aspects and of being practiced or of being carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. All numbers expressing measurements and so forth used in the specification and claims are to be understood as being modified in all instances by the term “about.”

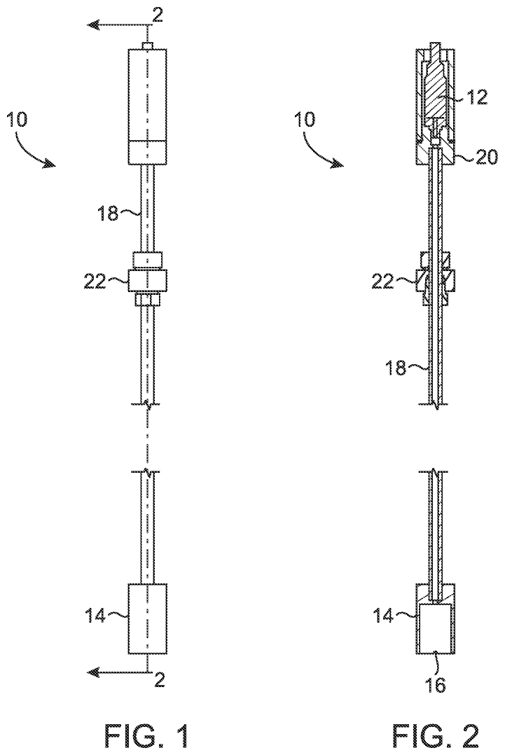

With initial reference to FIGS. 1 and 2, a level sensing monitor 10 adapted to be disposed in a reservoir or tank containing waste material along an axis of measurement to determine the level of material contained within the reservoir includes a pressure transducer 12 located at or near the top end of the monitor 10. A suitable pressure transducer may be one of the PT3020 series transducers available from Shanghai Hengrui Measurement & Control Co., Ltd. An inlet 14 is located at the opposite (bottom) end of the monitor 10, i.e., where the pressure is to be sensed.

The inlet 14 and the pressure transducer 12 are in fluid (i.e., air) communication via an airtight pipe 18, such as a ¼ SCH80 pipe, which permits the pressure present at the bottom of the pipe 18 near the inlet 14 to be sensed by the pressure transducer 12. The pipe 18 may be connected to the pressure transducer 12 using a coupler 20. The pipe 18 may be glued to the inlet 14 and may be connected to the transducer coupler 20 using, for example, pipe cement. However, any connection that is airtight is sufficient. A fitting 22 may be positioned along the pipe 18 to physically mount the level sensing monitor 10 to a reservoir or tank.

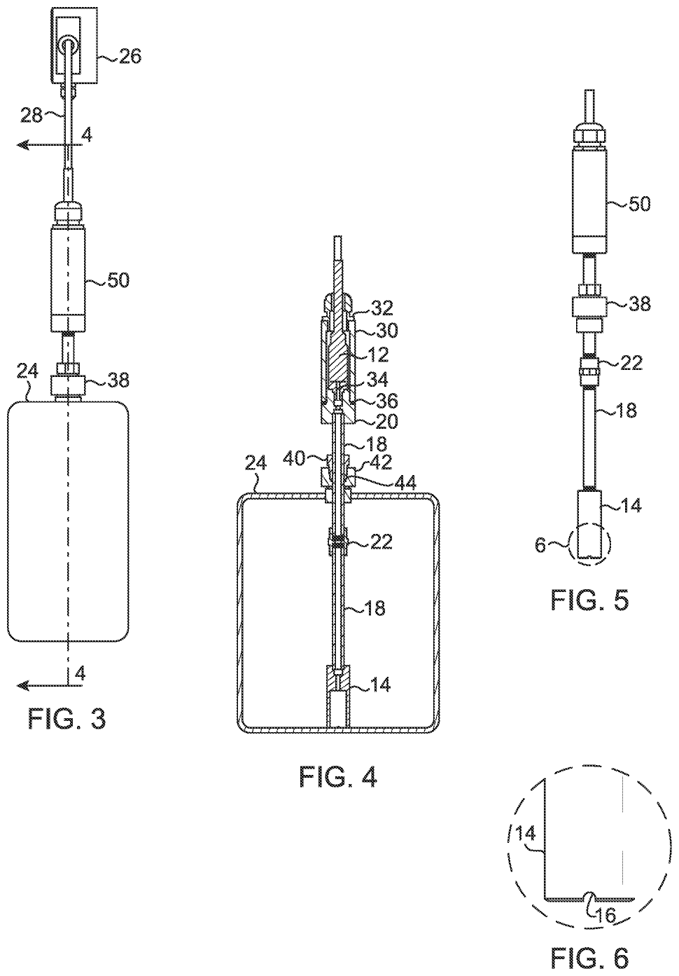

FIGS. 3-6 illustrate another embodiment of a level sensing monitor 10 in use with an arbitrarily sized tank 24. For use with a conventional manure pit, the top of tank 24 will include open slats opening into the containment housing for the hogs. The sensing monitor 10 preferably includes a wiring enclosure 26 that provides access to ambient air pressure. The return (atmospheric) pressure is provided to the pressure transducer 12 via a wiring cable 28. The wiring cable 28 also provides a means for the output signal from the pressure transducer 12 to reach a control system outside of the sensing monitor 10. Preferably, the pressure transducer 12 is enclosed for splash resistance as described below, and, therefore, the need for a separate wiring enclosure 26 that provides access to ambient pressure.

FIG. 4 illustrates further features of the level sensing monitor 10 that may be included in certain embodiments. The pressure transducer 12 may be contained within a housing 50 that includes a cover 30 and a watertight connection 32 to couple the pressure transducer 12 to the wiring cable 28. The transducer coupler 20 may mate with a sensor O-ring 34 and a cover O-ring 36 to form an air- and water-tight seal between the pressure transducer 12 and the pipe 18.

The sensing monitor 10 may also include a coupling 38 to the tank 24. This coupling 38 may include a compression bushing 40, a compression fitting 42, and a compression O-ring 44.

FIGS. 5 and 6 illustrate further detail on the inlet 14. The inlet 14 may include one or more notches 16 to ensure that the inlet 14 would not be sealed closed against the bottom of a tank 24.

Preferably, the sensing monitor 10 is installed within the reservoir or tank when it is empty, or with the monitor 10 held substantially vertical so as to not allow air to escape via the inlet 14. The bottom of the inlet 14 is the lowest level that the sensing monitor will detect and, therefore, it should be placed at or very near the bottom of the pit. Under normal installation circumstances, the bottom of the inlet 14 is preferably mounted some distance above the actual bottom of the pit, so that accumulated solids do not enter the inlet 14 in any significant quantity. For example, a typical distance may be 1.0 to 1.5 feet above the floor of the pit. Upon installation, air fills the entire pipe 18, which is only vented at the bottom of the inlet 14. As liquid levels rise in the pit, the liquid will cover the inlet 14, trapping a fixed amount of air in the enclosed space formed by the inlet 14, the pipe 18, and the transducer 12. As the liquid levels continue to rise (above the level that seals off the inlet 14), the air in the enclosed space will compress, transferring the pressure present at the bottom of the inlet 14 up to the pressure transducer 12 at the top of the pipe 18. The pressure may then be read by the transducer 12 and communicated via the wiring cable 28.

Preferably, the inside diameter of the inlet 14 is greater than the inside diameter of the pipe 18. The design of the inlet 14 described herein will dramatically diminish the degree to which liquid in the pit fouls the interior of the pipe 18. Given that the pressure increases as the liquid level rises, and the air that is in the pipe 18 is compressible, some liquid may invariably enter into the monitor 10 from the inlet 14. However, with the inside diameter of the inlet 14 designed to be larger than the inside diameter of the pipe 18, the liquid within the monitor 10 can be exclusively confined to the inlet 14. This arrangement provides many benefits including that the pipe 18 with the smaller inside diameter can be kept free of the liquid in the pit. In addition, the height of the liquid inside the inlet is reduced due to the greater inside diameter of the inlet relative to the pipe. Moreover, any solids that are contained in the pit will not clog the inlet 14, thereby causing the monitor 10 to function incorrectly.

Mounting the pressure transducer 12 at the top of the monitor 10, which is not immersed in the pit, keeps the transducer 12 from being fouled by the contents in the pit and may extend the life of the transducer 12. The use of an inlet 14 with a larger diameter than the pipe 18 enables the control (or limiting) of the quantity of pit material into the monitor 10. In one embodiment the ratio of the diameter of the inlet to the diameter of the pipe may be 5.5:1. For example, the inner diameter of the inlet 14 may be 1.55 inches and the inner diameter of the pipe 18 may be 0.282 inches. In addition, the use of a wiring enclosure 26 that is vented to ambient pressure enables the pressure transducer 12 to operate correctly. The ambient air is passed to the pressure transducer 12 via the wiring cable 28.

To facilitate shipping, the pipe 18 may be fabricated in discrete segments that are glued together as part of the installation process. Preferably, the glue seals are substantially air-tight and water-tight, using glue provided by the installer.

Having described the invention in detail, it will be apparent that modifications and variations are possible without departing the scope of the invention defined in the appended claims. In addition, those skilled in the art will readily appreciate that the level sensing monitor 10 may be readily used for other applications other than measuring the level of material in a hog manure pit including measuring the level of a wide variety of fluids such as fuels, oils, alcohol, milk, etc. Furthermore, it should be appreciated that all examples in the present disclosure are provided as non-limiting examples.

What is claimed is:

1. A level sensing monitor adapted to be partially disposed in a reservoir containing material along an axis of measurement to determine the level of material contained within the reservoir, the monitor comprising:
an inlet positioned on a lower end of the monitor adapted to be positioned near a bottom of the reservoir, wherein the inlet has a diameter;
a pressure transducer positioned on an upper end of the monitor distal from the inlet;
a substantially airtight hollow pipe coupled between the inlet and the transducer such that the transducer will reside above an upper level of the reservoir, wherein the pipe has an inner diameter that is smaller than the diameter of the inlet; and
a means for communicating readings from the transducer to determine the level of material contained within the reservoir.

2. The level sensing monitor of claim 1 wherein the means for communicating comprises a wiring cable housed in a wiring enclosure.

3. The level sensing monitor of claim 2 wherein the wiring enclosure is vented to ambient air to provide a source of ambient pressure to the pressure transducer.

4. The level sensing monitor of claim 1 further comprising a fitting positioned along the hollow pipe to mount the level sensing monitor 10 to the reservoir.

5. The level sensing monitor of claim 1 further comprising substantially air- and water-tight seals between the pressure transducer and the hollow pipe.

6. The level sensing monitor of claim 1 wherein the inlet comprises one or more notches to ensure that the inlet will not be sealed closed against the bottom of the reservoir.
